(19) United States
(12) Patent Application Publication
(10) Pub. No.: US 2012/0143363 A1
(43) Pub. Date: Jun. 7, 2012

(54) AUDIO EVENT DETECTION METHOD AND APPARATUS

(75) Inventors: Kun LIU, Beijing (CN); Weiguo Wu, Beijing (CN); Li Lu, Beijing (CN); Qingwei Zhao, Beijing (CN)

(73) Assignees: Institute of Acoustics, Chinese Academy of Scienc., Haidian District (CN); Sony Corporation, Tokyo (JP)

(21) Appl. No.: 13/312,231

(22) Filed: Dec. 6, 2011

(30) Foreign Application Priority Data
Dec. 6, 2010 (CN) 201010590438.1

(51) Int. Cl. G06F 17/00

(52) U.S. Cl. 700/94

(57) ABSTRACT

An audio event detection method and apparatus based on the long-term feature is provided. The audio event detection method comprises the step: dividing the input audio stream into a series of slices; extracting the short-term features and the long-term features for each slice; and obtaining the classification result of the input audio stream based on the short-term features and the long-term features.

### BACKGROUND

The present invention relates to an audio event detection method and apparatus, and particular to an audio event detection method and apparatus based on a long-term feature.

Today, the world is in a generation of the information explosion, and information is increased with a speed of the exponent level. The continuous development of the multimedia technology and the internet technology make a necessity of automatically analyzing and processing the large-scale multimedia data increase significantly. However, the amount of the computation of the video analysis is large, and more resource is consumed, thus the audio analysis of the multimedia data has a larger advantage.

In general, time of video such as a sports game is relatively long, and the content that truly interests most sports fans often only occupy a small section of the entire content. If it is necessary to find the interesting content, the user often need to go through the content from the beginning to the end to find the desired content, which costs time and labor. On the other hand, the more the sports videos are, the more the requirement for the effective retrieval and the management of the sport video is. Therefore, if there is a sports content retrieve system that can help the user to retrieve some contents truly cared about, the time can be largely saved.

In particular, the automatic audio analysis on sports game programs has got more attention from researchers. For a sports game, by extracting the highlight scene in the video of the sports game through the extraction of the audio event such as applauding, applause, cheering and laughing, it makes it possible for the user to find the interesting segment more conveniently.

The extraction of the audio event has the following difficulties: first, in the sports game, the audio event usually does not occur individually, instead, it is often accompanied by the speech of the preside and other sound, which causes difficulty for the modeling of the video event; second, in the sports game, the spectrum characteristic of the audio event is usually similar to the ambient noise, causing more pseudo-alarm generated in the retrieval procedure, so that the accuracy is relatively lower.

In the article “Perceptual linear predictive (PLP) analysis of speech” of Hermansky H (Journal of the Acoustical Society of America, 87:1738, 1990), the processing is through two stages. In the first stage, the multimedia data with a manual mark is relative audio searched with the semantic tag, and in the second stage, this type of music feature is on-line trained based on the audio search result of the semantic tag, and is applied to the query of the audio content.

It can be seen from the above literature that the related art only analyzes and detects certain content of one or two types of the sports games, and this technique has great pertinence, and can not extend to other types of the content detection for extracting the content of the sports game. And, with the increase of the types of sports games, the consumer is less likely to have enough time to view the entire game from the beginning to the end, therefore, the sports fans desire an automatic content detection system of the sports game for helping the user to detect the content interested fast and conveniently. Since the current image analysis technology is only limited to a scene analysis, there is not a good research on the understanding of the content of the image, thus this invention focuses on the use of the voice signal processing technology to understand and analyze the content of the sports games, to help the sports fans to extract some interesting event and information, such as match detection according to type, highlight event detection, key name of person and group, and the detection of the start point and the end time point of the different matches, etc.

### SUMMARY

In view of this, the present invention provides an audio event detection method and apparatus with robustness and high performance, wherein the audio event comprises: applauding, cheering and laughing. This method considers the continuity of the feature on the time domain, and detects in combined with a long-term feature based on slices, so that the performance of the detection is increased significantly.

According to an aspect of the present invention, the present invention provides an audio event detection method based on a long-term feature, the method comprises the step: dividing an input audio stream into a series of slices; extracting a short-term feature and a long-term feature for each slice; and obtaining a classification result of the audio stream based on the short-term features and the long-term features.

According to the aspect of the present invention, the audio event detection method further comprises a step of obtaining an event detection result through a smoothing processing of the classification result.

According to the aspect of the present invention, the audio event detection method further comprises the step of calculating a Mean Super Vector feature based on the long-term feature, after extracting the short-term feature and the long-term feature.

According to the aspect of the present invention, the audio event detection method further comprises the step of reducing dimensions of the Mean Super Vector by using a dimension reduction algorithm to remove redundant information, after calculating the Mean Super Vector feature.

According to the aspect of the present invention, in the audio event detection method, the short-term feature is based on a frame and the long-term feature is based on the slice.

According to the aspect of the present invention, in the audio event detection method, classification result comprises using a Support Vector Machine to classify the input audio stream.

According to the aspect of the present invention, in the audio event detection method, based on the short-term feature based on the frame comprises at least one feature of: PLP, LPCC, LFCC, Pitch, short-term energy, sub-band energy distribution, brightness and bandwidth.

According to the aspect of the present invention, in the audio event detection method, based on the long-term feature based on the slice comprises at least one feature of: spectrum flux, long-term average spectrum and LPC entropy.

According to the aspect of the present invention, in the audio event detection method, the obtaining the event detection result through the smoothing processing comprises using a smoothing rule in the smoothing processing, and the smoothing rule is as follows:

if {s(n)==1 and s(n+1)!=1 and s(n+2)==1} then s(n+1)=1 (1)

if {s(n)==1 and s(n−1)!=1 and s(n+1)!=1} then s(n)=s(n−1) (2)

According to another aspect of the present invention, the present invention provides an audio event detection apparatus based on a long-term feature, the apparatus comprises: an audio stream dividing section for dividing the input audio stream into a series of slices; a feature extracting section for extracting short-term features and long-term features for each slice; and classifying section for obtaining a classification result of the input audio stream based on the extracted short-term features and the long-term features.

According to another aspect of the present invention, the present invention provides a computer product for causing the computer to execute the steps of: dividing the input audio stream into a series of slices; extracting short-term features and long-term features for each slice; and obtaining a classification result of the input audio stream based on the short-term features and the long-term features.

In summary, by dividing the input audio stream into a series of slices, the present invention averages the feature vector of the slice (obtaining the MSV, Mean Super Vector), extracts the short-term features and the long-term features for each slice using the dimension reduction method, obtains the final classification result using SVM (supporting vector machine classifier), and obtain the final event detection result through smoothing. The experimental result shows that the result of event detection can reach an F value of 86% in the common TV program.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 shows a flowchart of one example of the audio event detection method based on the long-term feature according to the embodiment of the invention;

FIG. 2 shows the graph of the example of using filter group in LFCC and LFCC, wherein FIG. 2A is a graph showing one example of multiple scale filter group for LFCC, and FIG. 2B is a graph showing one example of linear filter group for LFCC;

FIG. 3 shows a flowchart of another example of the audio event detection method based on the long-term feature according to the embodiment of the invention;

FIG. 4 shows a block diagram of one example of the audio event detection apparatus based on the long-term feature according to the embodiment of the invention;

FIG. 5 is a block diagram showing the detailed structure of the feature extracting section according to the present invention;

FIG. 6 shows a flowchart of another example of the audio event detection apparatus based on the long-term feature;

FIG. 7 is a graph showing the dimension reduction result by employing three kinds of dimension reduction algorithm of LDA, PCA and ICA; and

FIG. 8 is a graph showing the feature detection performance dimension-reducing the PLP, LPCC and LFCC and the respective one-step, two-step differential thereof using LDA and the dimension-reduced feature+feature of other slices.

### DETAILED DESCRIPTION

The audio event detection method and apparatus based on the long-term feature according to the present invention is described with reference to the figure.

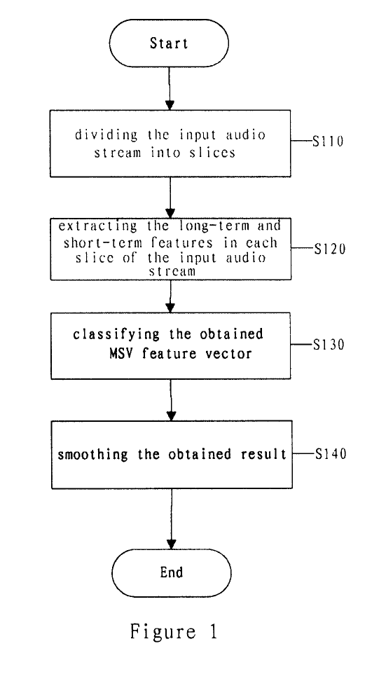

FIG. 1 shows a flowchart of one example of the audio event detection method based on the long-term feature according to the embodiment of the invention. Referring to FIG. 1, the audio event detection method based on the long-term feature comprises an audio stream dividing step S110, in the step S110, the audio steam to be processed is divided into a series of slices so as to extract the short-term features and the long-term features for each slice. Here, for dividing the input voice signal into a series of slices, the voice signal is divided into a series of voice window using the sliding window, and each voice window corresponds to one slice. Thus the dividing purpose is achieved.

The audio event detection method based on the long-term feature further comprises a long-term feature extracting step S 120, in the step S120, the short-term features and the long-term features are extracted for each slice. According to one embodiment of the present invention, for each slice, two features respectively based on frame and based on the slice, i.e., frame feature and slice feature can be extracted for each slice feature vector thereof.

Here, the features based on frame comprises at least one of the following features: PLP (Perceptual Linear Predictive Coefficients), LPCC (Linear Predictive Cepstrum Coefficients), LFCC (Linear Frequency Cepstral Coefficients), Pitch, STE (Short-term energy), SBED (Sub-band energy distribution), BR and BW (Brightness and bandwidth). And the features based on slice comprise at least one of the following features: SF (Spectrum Flux), LTAS (long-term average spectrum) and LPC entropy.

In particular, the PLP feature is a technology for voice analysis from three acoustical psychology aspects of equal-loud curve, strength energy theorem and critical spectrum analysis, the detailed algorithm refers to Hynek Hermansky: Perceptual Linear Predictive (PLP) analysis of speech, J. Acoust. Soc. Am. 87(4), April 1990. LPCC is a parameter feature based on sound track, and LFCC is a parameter feature taking the acoustical feature of the human ear into account, the detailed computation method refers to Jianchao Y U, Ruilin ZHANG: the Recognition of the speaker based on LFCC and LPCC, The engineering and design of Computer, 2009, 30(5). There are some differences between the LFCC and LPCC, For LFCC, it is necessary to map the energy in the common frequency to the Mel spectrum more compliant with the human hearing considering the perceptual characteristic of the human ear, while LPCC processes the frequency with a series linear triangular window in the common frequency domain instead of mapping on the Mel spectrum.

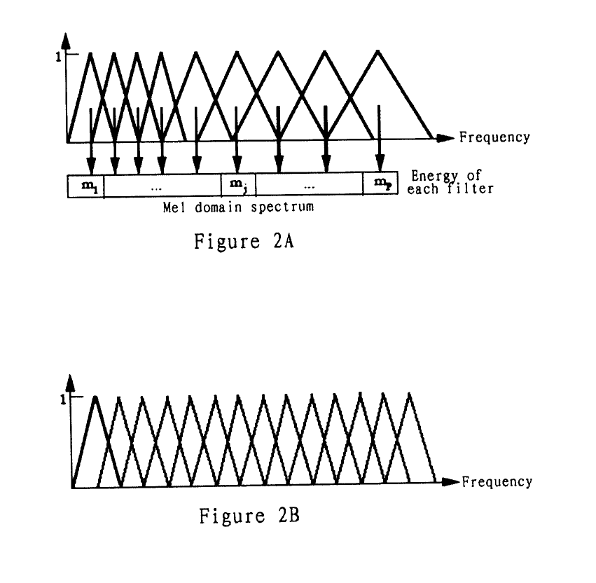

FIG. 2 is a graph of the example of using filter group in LFCC and LPCC, wherein FIG. 2A is a graph showing one example of multiple scale filter group for LFCC, and FIG. 2B is a graph showing one example of linear filter group for LPCC. The abscissa in FIG. 2 represents the frequency, and ordinate represents the amplitude of the triangular filter. Pitch is an important parameter of the analysis and synthesize of voice, music. In general, only the sonant has definite tone. However, the basic frequency of any sound wave can be represented by the fundamental frequency. It is not easy to extract the basic-frequency feature from the audio signal accurately and reliably. According to the different requirement of accuracy and complexity, different basic-frequency estimating method can be used, including auto-regressive model, average magnitude difference function, the maximum post-authenticating possibility method, etc. The present invention employs the self-related method.

The short-term energy of one dimension is extracted by using formula (1), the short-term energy describes the total spectrum energy of one frame.

STE=log (∫₀^{ω}^{₀}|F(ω)|²dω) (1)

Wherein ω₀ is a half of the sampling frequency of audio, F(ω) is fast-Fourier coefficient, |F(ω)|² is the energy at frequency ω. This feature can distinguish the voice/music and the noise relatively well.

If the spectrum is divided into some sub-band, the distribution of the sub-band energy is defined as ratio of the sub-band energy on the sub-band and the short-term energy of the frame. The expression is expressed as formula (2).

$$SBED = \frac{{\int }_{{L}_{j}}^{{H}_{j}} {\vert F ( ω ) \vert}^{2} d ω}{STE} \qquad ( 2 )$$

Wherein Lⱼ and Hⱼ is the up-limit frequency and the down-limit frequency on the j^{th} sub-band, respectively.

The brightness and the bandwidth are expressed by formula (3) and (4) as follows:

$$\begin{matrix}BR = \frac{{\int }_{0}^{{ω}_{0}} ω {\vert F ( ω ) \vert}^{2} d ω}{{\int }_{0}^{{ω}_{0}} ω {\vert F ( ω ) \vert}^{2} d ω} & ( 3 ) \\ BW = \frac{{\int }_{0}^{{ω}_{0}} ( ω - Br ) {\vert F ( ω ) \vert}^{2} d ω}{{\int }_{0}^{{ω}_{0}} {\vert F ( ω ) \vert}^{2} d ω} & ( 4 )\end{matrix}$$

Next, the spectrum flux is used for representing the variation between the spectrum of the continuous two frames, its expression is as formula (5):

$$SF = \frac{1}{( M - 1 ) ( K - 1 )} \times {\sum }_{n = 1}^{M - 1} {\sum }_{k = 1}^{K - 1} {\vert log ( \vert fft ( n , k ) \vert ) - log ( \vert fft ( n - 1 , k ) \vert ) \vert}^{2} \qquad ( 5 )$$

Wherein M is the number of frames in this slice, and K is the number of orders of FFT.

The long-term average spectrum is expressed as in the following formula (6).

$$LTAS = \frac{1}{L} {\sum }_{i = 1}^{L} {PSD}_{i} ( k ) \qquad ( 6 )$$

Wherein PSDᵢ is the power spectrum intensity of i^{th} frame, and L (25 in this application) is the number of frames syncopated in this slice.

$$PSD ( k ) = \frac{{\vert X ( k ) \vert}^{2}}{N ( {t}_{2} - {t}_{1} )} = \frac{{\vert {\sum }_{n = 0}^{N - 1} x ( n ) {e}^{- i kn} \vert}^{2}}{N ( {t}_{2} - {t}_{1} )}$$

Wherein k is the frequency, N is the number of orders of DFT (512 in this application), t1 and t2 is the starting time and ending time of this slice. Further, the statistical value of LTAS such as average value, minimum value, maximum value, mean square error, range of variation, local peak is extracted as well.

Further, the LPC entropy is mainly used for describing the variation of the spectrum on the time domain, which is expressed as formula (7).

$$Etr = - \frac{1}{D} {\sum }_{d = 1}^{D} {\sum }_{n = 1}^{w} {P}_{dn} log {P}_{dn} \\ {P}_{dn} = {\vert a ( n , d ) \vert}^{2} / {\sum }_{n = 1}^{w} {\vert a ( n , d ) \vert}^{2} \qquad ( 7 )$$

Wherein a(n,d) is the LPC coefficient, w is the length of the window, and D the number of orders of LPC.

Therefore, with the above audio stream long-term feature extracting step S120, the voice signal is divided into a series of voice window using the sliding window, the frame feature and slice feature are extracted for each voice window and the frame therein, so as to obtain the MSV (Mean Super Vector) feature vector.

Please note that in this invention, the following process can be performed with both or one of the two features based on frame and based on slice.

Next, back to refer to FIG. 1, in the classifying step S130, according to the short-term frame features and the long-term slice features extracted in step S120, the final classifying result is obtained with SVM (Support Vector Machine). With this method, in order to distinguish the audio event and the voice/music/noise and so on, the corresponding model such as model for voice, music, noise, cheering or applaud is trained first. Certain training audio data need to be annotated in advance, where is the voice and where is the music or noise, cheering, applaud need to be annotated in the audio data, and for each audio type, a certain number of annotated data is necessary to train the model of the corresponding type, and the tool of LIBSVM (referring to http://www.csie.ntu.edu.tw/˜cjlin/libsvm/) is employed for the training. First, the feature of each type of the data is extracted; each type of the feature data is written into the data format usable by LIBSVM (referring to http://baike.baidu.com/view/598089.htm); the executable file is called for training each type of feature into the corresponding type of model; then the test file to be classified is classified with the model obtained by training. The method for classifying is various, such as Gaussian Mixture Model (GMM), Hidden Markov Model (HMM) (referring to http://en.wikipedia.org/wiki/Hidden_Markov_model), etc. The content can also refer to (Douglas A. Reynolds, Thomas F. Quatieri, and Robert B. Dunn, Speaker Verification Using Adapted Gaussian Mixture Models, Digital Signal Processing 10, 19-41 (2000)).

Finally, in the smoothing step S140, the final event detection result is obtained by smoothing. Here, the smoothing process is mainly used for removing the classification error results, including the pseudo-alarm and non-integrity. The smoothing regulation defined is expressed as follows:

if {s(n)==1 and s(n+1)!=1 and s(n+2)==1} then s(n+1)=1 1)

if {s(n)==1 and s(n−1)!=1 and s(n+1)!=1} then s(n)=s(n−1) (2)

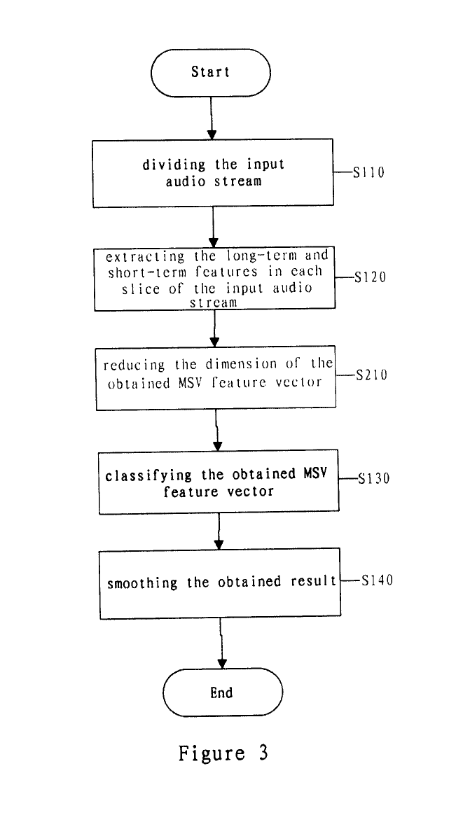

FIG. 3 shows a flowchart of another example of the audio event detection method based on the long-term feature according to the embodiment of the invention. Referring to FIG. 3, the audio event detection method as shown in this figure is different from the audio event detection method in FIG. 1, wherein in the audio event detection method as shown in FIG. 3 further comprises the feature dimension reduction step S210. In step S210, the dimension reduction algorithm is employed to reduce the dimension of the MSV feature vector after extracting the features based on frame and based on slice, so as to remove the redundancy information of the feature and obtain the main feature. The dimension of the feature is reduced significantly, and the performance can be improved at a certain level.

The commonly used dimension reduction methods include Principal component analysis (PCA), Linear Discriminative Analysis (LDA), Independent Component Analysis (ICA), and so on.

Beside the above difference in FIG. 3, other steps are same as the method in FIG. 1. Therefore, the same reference number is assigned to the common step, and the description thereof is omitted.

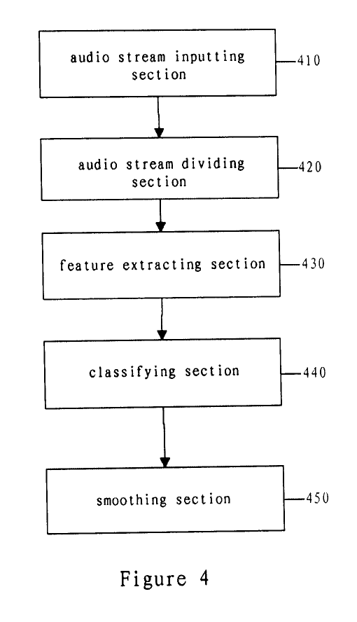

FIG. 4 shows a block diagram of one example of the audio event detection apparatus based on the long-term feature according to the embodiment of the invention. Referring to FIG. 4, the audio event detection device based on the long-term feature comprises the audio stream inputting section 410, the audio stream dividing section 420, the feature extracting section 430, classifying section 440 and smoothing section 450.

The audio stream to be processed is input into the audio stream dividing section 420 from the audio stream inputting section 410. The audio stream to be processed inputted by the audio stream inputting section 410 is divided into a series of slices to facilitate the extraction of a short-term feature and a long-term feature of each slice. Here, in order to divide the input audio signal, the voice signal can be divided into a series of voice windows using the sliding window, each voice window corresponding to a slice, so as to achieve the object of division. The audio stream dividing section 420 also input the division result to the feature extracting section 430 to extract the short-term features and the long-term features of each slice.

In a embodiment of the invention the feature extracting section 430 extracts at least the features based on frame and the features based on slice, i.e., the frame feature and the slice feature. Here, the frame feature comprises at least one of PLP, LPCC, PFCC, Pitch, short-term energy, sub-band energy distribution, brightness, bandwidth, and so on. And the slice feature comprises at least one of spectrum flux, long-term average spectrum, LPC entropy, and so on.

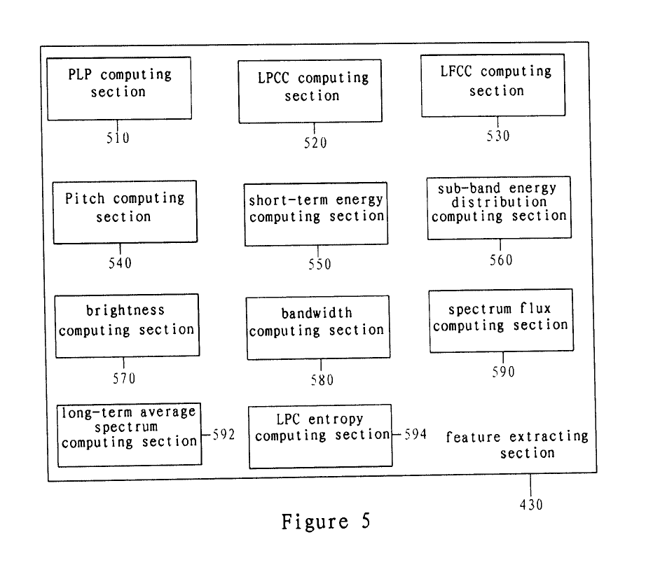

FIG. 5 is a block diagram showing the detailed structure of the feature extracting section 430 according to a embodiment of the present invention. As shown in FIG. 5, the feature extracting section 430 according to the present invention comprises the PLP computing section 510, the LPCC computing section 520, the LFCC computing section 530, the pitch computing section 540, the short-term energy computing section 550, the sub-band energy distribution computing section 560, the brightness computing section 570, the bandwidth computing section 580 for computing the frame feature. The feature extracting section 430 further comprise the spectrum flux computing section 590, the long-term average spectrum computing section 592, the LPC entropy computing section 594 for computing the slice feature.

The LPCC computing section 520, the LFCC computing section 530 and the pitch computing section 540 are used for computing PLP, LPCC, LFCC and Pitch according to the conventional method. As above mentioned, the detail of computation can refer to Hynek Hermansky (Perceptual Linear Predictive (PLP) analysis of speech, J. Acoust. Soc. Am. 87 (4), April 1990), and the word of Jianchao Y U, Ruilin Zhang, et (the recognition of the speaker based on LFCC and LPCC, the computer engineering and design, 2009, 30(5)).

The short-term energy computing section 550 extract the short-term energy describing the total spectrum energy in one frame using the formula (1). The sub-band energy distribution computing section 560 computes the sub-band energy distribution using formula (2). The brightness computing section 570 and the bandwidth computing section 580 compute the brightness and bandwidth using the formulas (3) and (4), respectively.

Next, the spectrum flux computing section 590 computes the spectrum flux using formula (5). The long-term average spectrum computing section 592 computes the long-term average spectrum using formula (6). The LPC entropy computing section 594 computes the LPC entropy using formula (7).

Back to FIG. 4, the classifying section 440 uses the final classification result obtained with SVM. With this method, in order to distinguish the audio event from voice/music/noise, etc., the corresponding model such as models for voice, music, noise, cheering, applause is trained firstly.

The smoothing section 450 obtains the final event detection result by smoothing. Here, the smoothing process is mainly used for removing classification error result including pseudo-alarm and non-integrity.

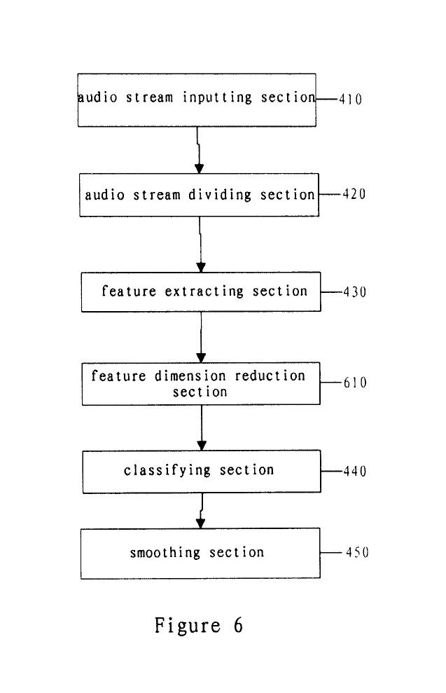

FIG. 6 shows a flowchart of another example of the audio event detection apparatus based on the long-term feature. Referring to FIG. 6, the audio event detection apparatus as shown in this figure is different from the audio event detection apparatus shown in FIG. 4, wherein the audio event detection apparatus shown in FIG. 6 further comprises the feature dimension reduction section 610 which reduces the dimension of MSV feature vector employing the dimension reduction algorithm after extracting the two features based on frame and based on slice to remove the redundancy information of the feature so as to obtain the main feature. For instance, the common dimension reduction methods include PCA, LDA, ICA, etc. The configuration of the audio event detection apparatus as shown in FIG. 6 is the same as that of the audio event detection apparatus as shown in FIG. 4 except the feature dimension reduction section 610, the same reference number would be assigned to the common components, and the description thereof will be omitted.

The experimental result shows that the result of the event detection can reach an F value of 86% in the general TV program. Table 1 shows the content and length of the data for training, and Table 2 shows the data for testing.

TABLE 1

| Type | Time (minutes) |
|---|---|
| Applaud | 54.41 |
| Laughing | 12.36 |
| Cheering | 54.85 |
| Voice | 60.08 |
| Noise | 46.99 |
| Music | 54.60 |

TABLE 2

| Type of program | Time (hours) |
|---|---|
| Entertainment | 0.97 |
| Sport | 1.50 |
| Chat | 3.14 |
| Others (arbitrary type) | 1.97 |

It can be seen from Table 1 and Table 2, the data content referred to comprises: Talking of News, Xiaocui Talking, Conference of Wulin, Serving for you, Common time all over the world, face to face, focus talking, recording, New oriental time, story of wealth, archive of the people, program for the Senior, joke, speaking, authenticating, sport match, etc. In these data, the training data and testing data are distributed by 4:1, the two types of data are not overlapped. 4 copy is used for training data, and 1 copy is used for testing data.

As the experimental result, Table 3 shows the condition of the obtained detailed number of feature dimension. In particular, Table 3 shows the number of dimension of each feature.

TABLE 3
The explanation of the number of the dimension of the feature

| | | | | | | | | Sub-band | | | |
|---|---|---|---|---|---|---|---|---|---|---|---|
| | | | | | | | | energy | Spectrum | | |
| Feature | LFCC | PLP | STE | LPCC | Pitch | Brightness | Bandwidth | distribution | flux | LTAS | LPC_Etr |
| Dimension | 24 | 12 | 1 | 12 | 1 | 1 | 1 | 8 | 1 | 6 | 1 |

The experiment is mainly used for authenticating whether there is an improvement of the performance of detection after adding new feature. Table 4 shows the performance of the detection according to the above method of the present invention.

TABLE 4
the validity of the feature

| Group of feature | Precision | Recall | F Value |
|---|---|---|---|
| PLP | 56.27% | 63.44% | 59.64% |
| +STE + SBED | 78.14% | 63.51% | 70.07% |
| +SP + BR + BW | 89.11% | 63.99% | 74.48% |
| +Pitch | 92.24% | 66.22% | 76.17% |
| +LFCC | 84.00% | 76.24% | 79.71% |
| +LPCC | 86.77% | 76.17% | 80.77% |
| +LTAS + LPC_Etr | 85.66% | 79.26% | 82.33% |

It can be seen from Table 4, only with the PLP feature, the Precision is 56.27%, the Recall is 63.44%, the F value is 59.64%, and after adding the STE and SBED feature, the Precision increases to 78.14%, the Recall is 63.51%, the F Value if 70.07%; and the like. The classifier used here is SVM, and the definition of F Value is expressed by formula (8).

$$F \text{-} Value = \frac{2 \cdot Precision \cdot Recall}{( Precision + Recall )}$$

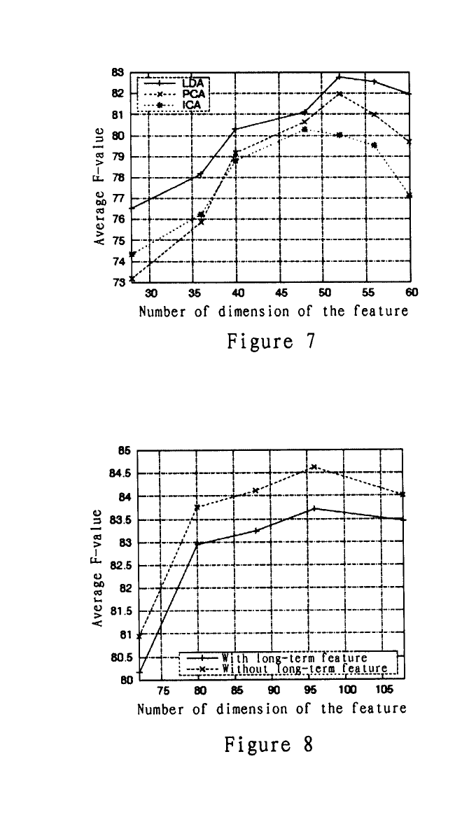

FIG. 7 is a graph showing the dimension reduction result by employing three kinds of dimension reduction algorithm of LDA, PCA and ICA. In the embodiment of the present invention, it performs a dimension-reduction for the frame feature except for the slice feature. Referring to FIG. 7, the performance of three different dimension reduction algorithms of LDA, PCA, and ICA is compared in the graph. It can be seen from the figure that the performance of LDA is better than the other two methods.

FIG. 8 is a graph showing the feature detection performance dimension reducing the PLP, LPCC and LFCC and the respective one-step, two-step differential thereof using LPA and the dimension-reduced feature+feature of other slices. It can be seen from the graph that the performance after adding the slice feature is better.

Further, with the comparison between the classifying effect of the above SVM classifier and the effect of GMM (Gaussian mixture mode) classifier, it can be seen the performance of the SVM classifier will be higher than the performance of the GMM by about 5% on the same feature. Here, the Table 5 shows the performance of GMM.

TABLE 5
the performance of the system based on GMM

| Group of feature | Precision | Recall | F Value |
|---|---|---|---|
| PLP | 50.27% | 59.48% | 54.47% |
| +STE + SBED | 69.88% | 60.01% | 64.57% |
| +SP + BR + BW | 84.67% | 60.83% | 70.80% |
| +Pitch | 86.32% | 61.40% | 71.76% |
| +LFCC | 81.22% | 71.49% | 76.04% |
| +LPCC | 82.21% | 72.39% | 76.98% |
| +LTAS + LPC_Etr | 81.98% | 73.16% | 77.32% |

Further, the processing procedure described in the embodiment of the present invention can be provided as the method with the procedure sequence. Further, these procedure sequences can be provided as program which causes the procedure sequence executed in the computer and the record medium recording the program. CD (compact-disc), MD (mini-disk), DVD (digital versatile disk), memory card, blue-disc (registered trademark) and so on are used for this record medium.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. An audio event detection method comprising the steps of:
dividing an input audio stream into a series of slices;
extracting a short-term feature and a long-term feature for each slice; and
obtaining a classification result of the input audio stream based on the short-term features and the long-term features.

2. The audio event detection method according to claim 1, further comprising the step of: obtaining an event detection result through a smoothing processing of the classification result.

3. The audio event detection method according to claim 1, further comprising the step of calculating a Mean Super Vector feature based on the long-term feature, after extracting the short-term feature and the long-term feature.

4. The audio event detection method according to claim 3, further comprising the step of reducing dimensions of the Mean Super Vector by using a dimension reduction algorithm to remove redundant information, after calculating the Mean Super Vector feature.

5. The audio event detection method according to claim 1, wherein the short-term feature is based on a frame and the long-term feature is based on the slice.

6. The audio event detection method according to claim 1, wherein the obtaining the classification result comprises using a Support Vector Machine to classify the input audio stream.

7. The audio event detection method according to claim 5, wherein the short-term feature based on the frame comprises at least one feature of: PLP, LPCC, LFCC, Pitch, short-term energy, sub-band energy distribution, brightness and bandwidth.

8. The audio event detection method according to claim 5, wherein the long-term feature based on the slice comprises at least one feature of: spectrum flux, long-term average spectrum and LPC entropy.

9. The audio event detection method according to claim 2, wherein the obtaining the event detection result through the smoothing processing comprises using a smoothing rule in the smoothing processing, the smoothing rule is as follows:
if {s(n)==1 and s(n+1)!=1 and s(n+2)==1} then s(n+1)=1 (1)
if {s(n)==1 and s(n−1)!=1 and s(n+1)!=1} then s(n)=s(n−1) 2)

10. An audio event detection apparatus comprising:
an audio stream dividing section for dividing an input audio stream into a series of slices;
a feature extracting section for extracting a short-term feature and a long-term feature for each slice; and
a classifying section for obtaining a classification result of the input audio stream based on the short-term features and the long-term features.

11. The audio event detection apparatus according to claim 10, further comprising a smoothing section for obtaining an event detection result through a smoothing processing of the classification result.

12. The audio event detection apparatus according to claim 10, wherein the feature extracting section further calculates a Mean Super Vector based on the long-term feature.

13. The audio event detection apparatus according to claim 12, further comprising feature dimension reduction section for reducing dimensions of the Mean Super Vector by using a dimension reduction algorithm to remove redundant information.

14. The audio event detection apparatus according to claim 10, wherein the short-term feature is based on frame and the long-term feature is based on the slice.

15. The audio event detection apparatus according to claim 10, wherein the classifying section classifies the input audio stream using a Support Vector Machine.

16. The audio event detection apparatus according to claim 14, wherein the short-term feature based on the frame comprises at least one feature of: PLP, LPCC, LFCC, Pitch, short-term energy, sub-band energy distribution, brightness and bandwidth.

17. The audio event detection apparatus according to claim 14, wherein the long-term feature based on the slice comprises at least one feature of: spectrum flux, long-term average spectrum and LPC entropy.

18. The audio event detection apparatus according to claim 11, wherein the smoothing section uses a smoothing rule in the smoothing processing, the smoothing rule is as follows:
if {s(n)==1 and s(n+1)!=1 and s(n+2)==1} then s(n+1)=1 (1)
if {s(n)==1 and s(n−1)!=1 and s(n+1)!=1} then s(n)=s(n−1) (2)

19. A computer product for causing a computer to execute the steps of:
dividing the input audio stream into a series of slices;
extracting the short-term features and the long-term features for each slice; and
obtaining the classification result of the input audio stream based on the short-term features and the long-term features.
